(19) United States
(12) Patent Application Publication
(10) Pub. No.: US 2002/0136932 A1
(43) Pub. Date: Sep. 26, 2002

(54) GaN-based light emitting device

(76) Inventor: Seikoh Yoshida, Tokyo (JP)

Correspondence Address: COUDERT BROTHERS, LLP, 600 Beach Street, 3rd Floor, San Francisco, CA, 94109, US

(21) Appl. No.: 10/098,216

(22) Filed: Mar. 15, 2002

(30) Foreign Application Priority Data
Mar. 21, 2001 (JP) 2001-80739
Mar. 21, 2001 (JP) 2001-80740
Apr. 26, 2001 (JP) 2001-129492

(51) Int. Cl. B32B 9/00

(52) U.S. Cl. 428/698; 428/697; 428/699; 428/704

(57) ABSTRACT

Disclosed is a GaN-based light emitting device which emits a high-luminance light and can emit lights of a wavelength range from ultraviolet to infrared and can emit white light. The GaN-based light emitting device comprises an active layer formed of a GaN-based compound semiconductor which includes N and at least one of As, P and Sb. The GaN-based compound semiconductor preferably has a composition expressed by GaN_{1-x-y}As_{y}Pₓ where x and y are values which are not zero at the same time and satisfy 0<x+y<1.

### BACKGROUND OF THE INVENTION

1. Field of the Invention

The present invention relates to a GaN-based light emitting device, and, more particularly, to a GaN-based light emitting device which emits a high-luminance light and can emit lights of a wavelength range from ultraviolet to infrared and can also emit white light.

2. Background of the Invention

Blue light emitting devices which use a GaN-based compound semiconductor having a large band gap energy as the material for an active layer have been developed and some of these devices have already been put into practical use.

In such devices, non-doped InGaN and AlInGaN, for example, are used as the GaN-based compound semiconductor for the active layer.

For example, Japanese Unexamined Patent Publication No. Hei 9-153642 discloses a blue light emitting device which has a buffer layer of GaN, a cladding layer of non-doped GaN, a lower cladding layer of n-AlGaN and having a large band gap energy and an active layer of non-doped InGaN laminated in this order on a sapphire substrate, further has an upper cladding layer of p-AlGaN and having a large band gap energy and a cap layer of p-GaN laminated on the resultant structure, forms a p-type electrode on the cap layer and forms an n-type electrode on the lower cladding layer (n-AlGaN layer).

In consideration of energy saving efforts nowadays, the blue light emitting device is desired to give the performance of emitting light with a high luminance even on a low applied voltage. In order to meet this desire, many problems must be overcome. One of the problems is to increase the crystallinity of a GaN-based compound semiconductor which constitutes the active layer.

Every GaN-based compound semiconductor mentioned above as the material for the conventional active layer belongs to a III-V group compound semiconductor. In this case, at least one kind of Ga, In and Al is used as the III group element. But, only N is used as the V group element. In case of InGaN, for example, the GaN-based compound semiconductor takes the form of a binary mixed crystal of GaN and InN.

As is also the case with other layers, the active layer is formed by epitaxial crystal growth, such as MOCVD, using a source for the aforementioned III group element and a source for the element N.

In this case, the crystal growth temperature which differs depending on the type of the source is set to about 850 to 1050° C.

In the temperature range, however, the vapor pressure of N as a V group element is relatively high as compared with that of the aforementioned III group element. Therefore, N tends to dissociate from a crystal lattice point during the crystal growth of the GaN-based compound semiconductor. As a result, the acquired epitaxial crystal has N-dissociated crystal lattice points. GaN-based compound semiconductors apparently have a high frequency of occurrence of crystal defects as compared with other III-V group compound semiconductors, such as GaAs and GaP.

Because of this shortcoming, the conventional light emitting devices whose active layers are formed of the aforementioned GaN-based compound semiconductor have not successfully accomplished emission of high-luminance lights.

K. Iwata, et al. suggest the below-mentioned possibility in Jpn. J. Appl. Phys. 35 (1996) L 1634.

In the case of a light emitting device whose active layer is made of GaNAs, which is a binary mixed crystal of GaN and GaAs, or GaNP, which is a binary mixed crystal of GaN and GaP, red light may possibly be emitted from the light emitting device if GaNAs having an As composition ratio of about 10% is used or if P in GaNP is set to about 15%.

In actuality, however, such a device has not been produced yet.

The reason is as follows:

Even if the composition ratio of As or P changes slightly, the band gap energies of those binary mixed crystals change greatly. Accordingly, the emission wavelength changes too.

It is apparently very difficult to acquire the aforementioned binary mixed crystals as epitaxial crystals that have compositions as designed and have fewer crystal defects.

### OBJECTS AND SUMMARY OF THE INVENTION

Accordingly, it is an object of the present invention to provide a GaN-based light emitting device whose active layer is formed of a GaN-based compound semiconductor and which can emit a light with a higher luminance than conventional GaN-based light emitting devices.

It is another object of the present invention to provide a GaN-based light emitting device which can emit lights of a wavelength range from ultraviolet to infrared and can even emit white light.

To achieve the objects, according to the present invention, there is provided a GaN-based light emitting device comprising an active layer formed of a GaN-based compound semiconductor including at least two kinds of V group elements.

Specifically, the GaN-based light emitting device has a layered structure which has a buffer layer of GaN, a cladding layer of non-doped GaN, a p-type cladding layer of p-AlGaN, the active layer of a non-doped GaN-based compound semiconductor, an n-type cladding layer of n-AlGaN and a cap layer of n-GaN laminated in the order named is provided on a substrate, an n-type electrode is formed on the cap layer and a p-type electrode is formed on the p-type cladding layer. (Hereinafter, this device is called “device A”.)

In the GaN-based light emitting device of the present invention, the active layer may include an island-shaped quantum dot structure formed of a GaN-based compound semiconductor (hereinafter, this device is called “device B”).

In the GaN-based light emitting device of the present invention, the active layer may be a plurality of light emitting areas which are formed of a GaN-based compound semiconductor and have different compositions and different areas of light emitting layers (hereinafter, this device is called “device C”).

In any of the devices, the GaN-based compound semiconductor is preferably a GaN-based compound semiconductor expressed by a formula:

GaN_{1-x-y}As_{y}Pₓ

where x and y are values which are not zero at the same time and satisfy 0<x+y<1.

### BRIEF DESCRIPTION OF THE DRAWINGS

FIG. 1 is a cross-sectional view showing one example A of a light emitting device according to the present invention;

FIG. 2 is a cross-sectional view showing another example B of the light emitting device according to the present invention;

FIG. 3 is a cross-sectional view showing a further example C of the light emitting device according to the present invention;

FIG. 4 is a cross-sectional view showing one example of a layered structure for fabricating the light emitting device A;

FIG. 5 is a cross-sectional view illustrating a layered structure which has a GaN buffer layer and a p-GaN layer laminated on a sapphire substrate in a process of fabricating the light emitting device B;

FIG. 6 is a cross-sectional view showing a state where a layer of a GaN-based compound semiconductor is formed on the layered structure in FIG. 5;

FIG. 7 is a cross-sectional view illustrating a layered structure in which island-shaped quantum dot structure is formed;

FIG. 8 is a cross-sectional view illustrating a layered structure in which an active layer of a single quantum well structure type for burying the quantum dot structure is formed;

FIG. 9 is a cross-sectional view illustrating a layered structure in which an n-GaN layer is formed on an active layer having a multilayered structure;

FIG. 10 is a cross-sectional view showing a state where a GaN buffer layer and a p-GaN layer are formed on a sapphire substrate in a process of fabricating the light emitting device C according to the present invention;

FIG. 11 is a cross-sectional view showing a state where a mask having openings with different opening areas are formed on the layered structure in FIG. 10;

FIG. 12 is a cross-sectional view showing a state where light emitting areas are formed by selective growth;

FIG. 13 is a cross-sectional view showing a state where an n-GaN layer is formed burying the light emitting areas shown in FIG. 12;

FIG. 14 is a graph showing the relationship among the crystal growth speed and composition of GaNP which is selectively grown on a GaN layer using a mask and the opening area of the mask; and

FIG. 15 is a graph showing the emission characteristic of the light emitting device B as an example 3.

### DETAILED DESCRIPTION

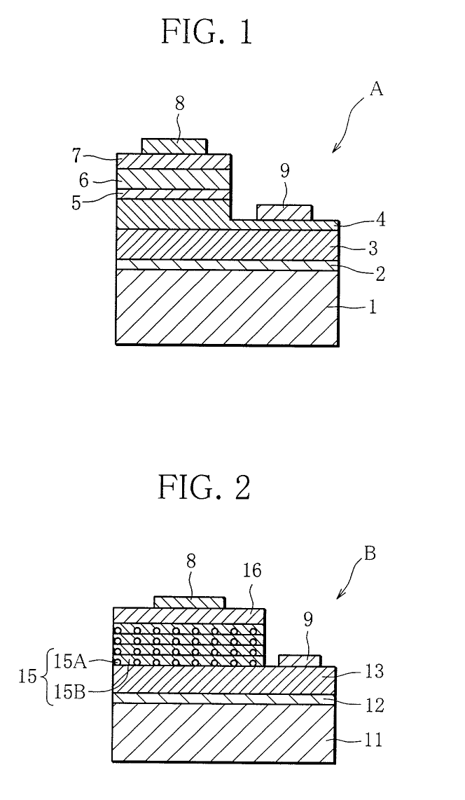

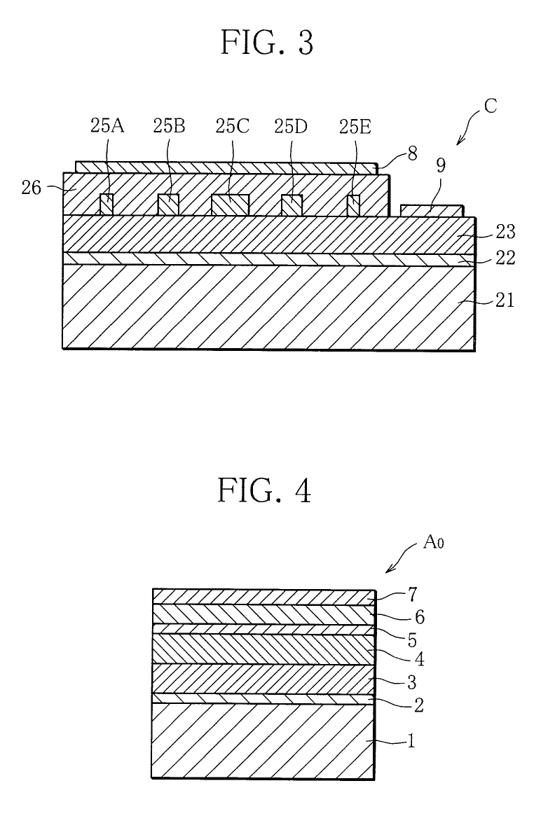

FIG. 1 shows one example A of a light emitting device according to the present invention, FIG. 2 shows another example B of the light emitting device, and FIG. 3 shows a further example C of the light emitting device.

The device A has an active layer 5 which is uniformly formed in thickness of a GaN-based compound semiconductor to be discussed later and which becomes a light emitting area. The device B has a layered structure in which quantum dots 15A to be discussed later are formed in an active layer 15 as emission centers. The device C has a plurality of areas 25A to 25E to be discussed later which are formed of a GaN-based compound semiconductor and as a whole becomes a light emitting area as an active layer. The main characteristics of these devices A, B and C is that all of the active layers are formed of III-V group compound semiconductors, or GaN-based compound semiconductors whose V group elements include N as an essential element and further include at least one kind selected from a group of As, P and Sb. While the III group element may be Ga alone, other III group element, such as In or Al, may substitute for a part of Ga as in the conventional case.

Some of specific examples of a GaN-based compound semiconductor to be used for the active layer are GaNP, GaNAs, GaNSb, GaNAsP, GaNAsSb, GaNPSb, InGaNP, InGaNAsP, InAlGaNAsP, InAlGaNPSbAs, AlGaNPAs, AlGaNPSb and eAlGaNAsSb.

As the active layer is formed of the above-mentioned GaN-based compound semiconductor, the light emitting device of the present invention emits light with a high luminance.

The reason for such emission, which has not been cleared, may be because the formed GaN-based compound semiconductor has fewer crystal defects as will be discussed below.

Any of the mentioned GaN-based compound semiconductors is a mixed crystal prepared by, for example, MOCVD. In case where the active layer is formed of GaNP, for example, the GaNP is a mixed crystal of GaN and GaP.

While GaN is apt to have crystal defects as mentioned earlier, crystal defects are difficult to occur in the process of the crystal growth of, for example, GaP. With regard to GaP, therefore, it is easy to acquire a crystal which has a composition as designed. This makes it possible to compensate for the dissociation amount of N with P or a V group element other than N by adequately adjusting the amount of P source at the time of crystal growth, e.g., by setting the concentration of P slightly higher than the designed value. The resultant GaNP becomes a mixed crystal of a III-V group compound semiconductor having fewer crystal defects than GaN alone.

That of the GaN-based compound semiconductors which is expressed by the following formula can allow the active layer formed of the GaN-based compound semiconductor to emit a light with any wavelength ranging from ultraviolet to infrared if the values of x and y are adequately selected.

GaN_{1-x-y}As_{y}Pₓ

where x and y are values which are not zero at the same time and satisfy 0<x+y<1.

For example, a GaN single crystal has a band gap of 3.3 to 3.4 eV and a peak emission wavelength of about 360 nm and emits an ultraviolet light. A GaP single crystal has a band gap of about 2.2 eV and a peak emission wavelength of about 560 nm and emits a green light. A GaAs single crystal has a band gap of about 1.5 eV and a peak emission wavelength of about 890 nm and emits an infrared light.

Although the semiconductor expressed by the formula (1) is a ternary mixed crystal of GaN, GaAs and GaP, the ternary mixed crystal would have a band gap different from (normally smaller than) the band gaps of the individual crystals if the values of x and y are independently set. The resultant mixed crystal emits light with the corresponding peak emission wavelength.

If the value of x is set to 0.15 in GaN₁₋ₓPₓ which is the formula (1) with y=0, for example, the crystal band gap becomes approximately 1.8 eV and the peak emission wavelength is about 650 nm, so that a red light is emitted.

The device A may be fabricated as follows.

A buffer layer 2 of GaN, a layer 3 of, for example, non-doped GaN, a p-type cladding layer 4 of, for example, p-AlGaN, an active layer 5 of non-doped GaNP, an n-type cladding layer 6 of, for example, n-AlGaN and a cap layer 7 of, for example, n-GaN are laminated in order on, for example, a sapphire substrate 1 by, for example, gas-source molecular-beam epitaxy (GSMBE), thus yielding a layered structure A₀ shown in FIG. 4.

Next, an SiO₂ film is deposited on the cap layer 7 of the layered structure A₀ by, for example, plasma CVD and is then patterned. With the SiO₂ film as a mask, a part of the layered structure is etched out to a part of the p-type cladding layer 4, thereby partially exposing the surface of the p-type cladding layer 4.

Then, the SiO₂ film is removed after which an SiO₂ film is deposited again on the entire surface of the resultant structure and electrode opening are formed in that SiO₂ film. Then, an n-type electrode 8 is formed on the cap layer 7 and a p-type electrode 9 is formed on the p-type cladding layer 4, thereby completing the device A.

When a driving voltage is applied to the n-type electrode 8 and p-type electrode 9, the active layer 5 emits a high-luminance light whose wavelength lies in a range from ultraviolet to infrared in accordance with the type of the GaN-based compound semiconductor that constitutes the active layer 5, as mentioned above.

If the active layer is formed to have a multilayered structure by laminating a plurality of layers of GaN-based compound semiconductors which are given by the formula (1) and whose compositions differ from one another, therefore, each active layer emits light specific to the compound semiconductor material used for that active layer. The device A can therefore emit lights of multiple colors.

In this case, if the multilayered structure is made to comprise three kinds of active layers by forming one active layer of a material for a blue light, another active layer of a material for a red light and the other one of a material for a green light, it is possible to emit a white light.

The method of forming the layered structure A₀ is not limited to GSMBE but MOCVD may be used as well. In the latter case, trimethylgallium, trimethylindium or trimethylaluminum, for example, may be used as the source for the III group element, ammonia may be used as the source for N, tertiary butyl phosphine or PH₃ may be used as the source for P, tertiary butyl arsine or AsH₃ may be used as the source for As and tertiary butyl antimony may be used as the source for Sb. Further, silane may be used as an n-type dopant and biscyclopentadienyl magnesium may be used as a p-type dopant.

The III group element in the GaN-based compound semiconductor for the active layer is not limited only to Ga, but other III group element, such as In or Al, particularly, In, may substitute for a part of Ga. The amount of substitution in that case is preferably about 0.5 or less in terms of the composition ratio.

In case of the device A in FIG. 1 where a p-type cladding layer is formed under the active layer 5 and an n-type cladding layer is formed on the active layer 5, the same advantage can be acquired if an n-type cladding layer is formed under the active layer 5 and a p-type cladding layer is formed on the active layer 5.

It is possible to use Ti/Al/Au, Al/Ti/Au, or Ta—Si, Ti—Si, Al—Si, W—Si and other siliside alloys for the n-type electrode 8 and use Ni/Al, Pt/Au, Pd/Pt/Au, Pt/Ni/Au, Ag/Ni/Au or the like for the p-type electrode 9.

The device B will be described below.

The device B has been developed based on the knowledge that as a thin layer of the above-described GaN-based compound semiconductor is formed on a GaN layer, the GaN-based compound semiconductor is self-aligned to transform into an island-shaped quantum dot structure of a fine single quantum well structure type and the quantum dot structure is capable of serving as an emission center.

If the quantum dot structure is buried with GaN to thereby form a GaN layer, therefore, the GaN layer becomes a light emitting layer which emits light with an emission wavelength corresponding to the composition of the GaN-based compound semiconductor that forms the quantum dot structure.

The device B may be fabricated as follows.

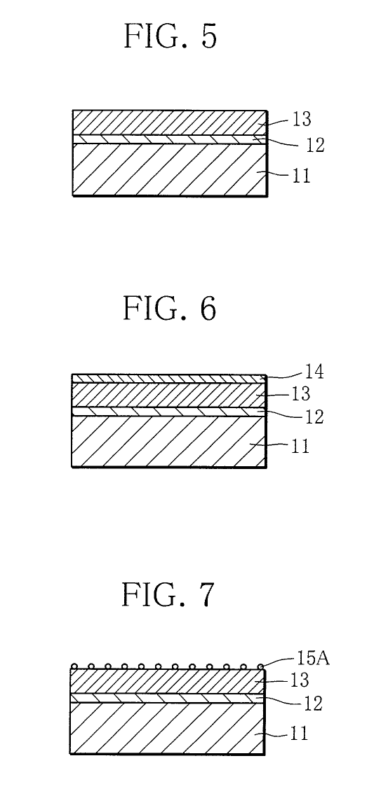

A buffer layer 12 of GaN is formed on a sapphire substrate 1 and a p-type layer 13 of p-GaN is further formed on the buffer layer 12 both by, for example, GSMBE (FIG. 5).

Then, a layer 14 of a GaN-based compound semiconductor, such as non-doped GaNP, is formed on the p-type layer 13 as shown in FIG. 6. The thickness of the layer 14 is controlled to be equal to or less than 10 monolayers (ML). Preferably, the thickness is controlled to about 1 or 2 ML.

The two-dimensional layer 14 of the GaN-based compound semiconductor with a thickness of about 1 ML or 2 ML which is formed on the p-type layer (p-GaN layer) 13 is self-aligned on the p-type layer 13 to transform into a three-dimensional island shape, thus yielding a plurality of quantum dot structures 15A scattered on the p-type layer 13 (FIG. 7).

It is possible to determine whether or not the quantum dot structures 15A have been formed by using a scheme, such as RHEED (Reflection High Energy Electron Diffraction).

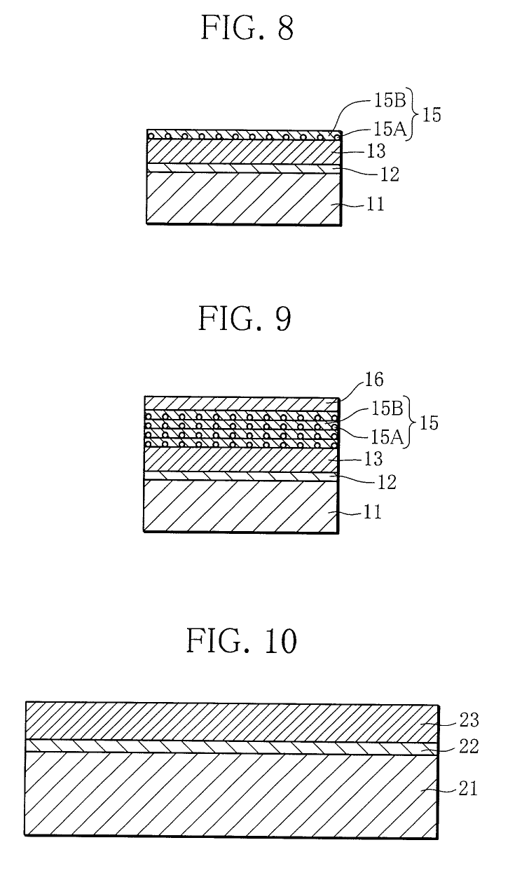

Then, as shown in FIG. 8, the quantum dot structures 15A are buried with, for example, non-doped GaN, thereby forming a non-doped GaN layer 15B having a thickness of, for example, about 2 to 3 nm.

A resultant layer 15 which is formed in the above-described manner has a quantum dot structure of a single quantum well structure type formed of, for example, GaNP/GaN. This layer 15 is a light emitting layer (active layer) whose quantum dot structures 15A serves as emission centers.

An active layer which has another quantum dot structure is formed of non-doped GaN is laminated on the layer 15 to thereby yield a multilayered structure and finally an n-type layer 16 of, for example, n-GaN is formed on the topmost portion (FIG. 9).

Then, an SiO₂ film is formed on the acquired layered structure and is etched as done in the case of the device A, thereby forming an n-type electrode 8 on the n-type layer 16 and a p-type electrode 9 on the p-type layer 13. This completes the device B shown in FIG. 2.

In the case of the device B, as the active layer 15 incorporates island-shaped quantum dot structures 15A which serves as emission centers, the emission intensity becomes higher than that in the case where the active layer is formed of non-doped GaN alone (e.g., in the case of the device A), resulting in a higher emission efficiency. This can achieve high-luminance light emission.

By adequately selecting the type of the GaN-based compound semiconductor used for the formation of the island-shaped quantum dot structures 15A, light emitted from the active layer 15 can be changed arbitrarily within a wavelength range from ultraviolet to infrared.

As a plurality of active layers 15 are laminated to form a multilayered structure, it is possible to make the whole active layer into a multiquantum well structure so that the acquired light emitting device has a sufficiently high emission intensity.

In this case, if the multilayered structure is made to comprise three active layers by forming the quantum dot structure in one active layer of a material for a blue light, the quantum dot structure in another active layer of a material for a red light and the quantum dot structure in the other one of a material for a green light, it is possible to emit a white light.

The device C will now be described.

As shown in FIG. 3, the device C has plural (five in FIG. 3) light emitting areas 25A, 25B, 25C, 25D and 25E of GaN-based compound semiconductors whose compositions differ from one another are arranged as active layers in a planar fashion on a p-type layer 23 of, p-GaN. Those light emitting areas have a layered structure which is buried with an n-type layer 26 of, for example, n-GaN. Then, an n-type electrode 8 is formed on the n-type layer 26 and a p-type electrode 9 is formed on the p-type layer 23.

The device C has been developed based on a new knowledge that in case where the GaN-based compound semiconductor is selectively grown on a GaN layer by using a mask, as the size of the opening in the mask changes, the crystal growth speed of the GaN-based compound semiconductor changes accordingly and as the crystal growth speed becomes faster, the incorporated amounts of the V group elements, such as P and As, become larger, thus increasing their composition ratio in the acquired GaN-based compound semiconductor.

The compositions of the light emitting areas 25A to 25E in the device C differ from one another. Accordingly, the band gaps differ from one another. Therefore, the individual light emitting areas emit lights of different wavelengths.

The device C may be fabricated as follows.

First, a buffer layer 22 of GaN and a p-type layer 23 of p-GaN are laminated in order on a sapphire substrate 1 by, for example, MOCVD, thereby yielding a layered structure shown in FIG. 10.

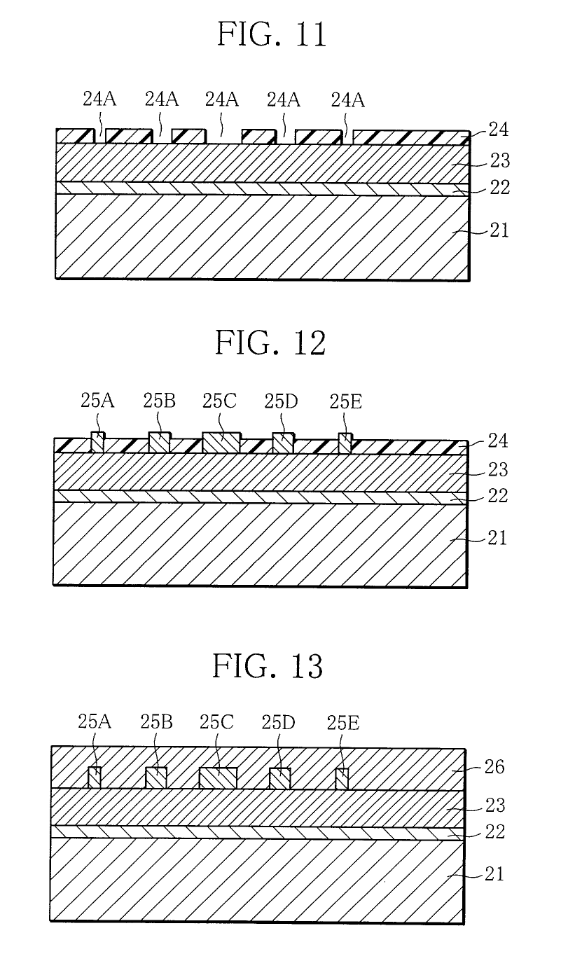

Next, an SiO₂ film is deposited on the p-type layer 23 with the layered structure by, for example, thermal CVD, after which the SiO₂ film is patterned and etched to form a mask 24 having a plurality of openings 24A as shown in FIG. 11.

Then, crystal growth of a GaN-based compound semiconductor is carried out again by MOCVD. The GaN-based compound semiconductor is selectively grown on the p-type layer 23 that is exposed through the openings 24A of the mask 24. As a result, the openings 24A are filled with the GaN-based compound semiconductor, thus forming the light emitting areas 25A to 25E as shown in FIG. 12.

Then, after the mask 24 is removed, n-GaN is deposited on the exposed p-type layer 23 to thereby form the n-type layer 26 with the light emitting areas 25A to 25E completely buried (FIG. 13).

Then, a part of the p-type 23 is exposed by partly removing the layered structure by, for example, dry etching, and the p-type electrode 9 and the n-type electrode 8 are respectively formed on the exposed surface and the surface of the n-type layer 26, thereby completing the device C shown in FIG. 3.

In the above-described sequence of fabricating steps, the opening areas of the openings 24A are adequately adjusted at the time of producing the mask 24 shown in FIG. 11 to thereby control the composition of the GaN-based compound semiconductor that is to be selectively grown there.

In case where the GaN-based compound semiconductor is GaNP and is selectively grown on GaN, for example, the relationship between the width of each opening 24A of the mask 24 (which corresponds to the opening area) and the crystal growth speed of GaNP becomes as shown in FIG. 14.

Specifically, in case where the mask 24 having an opening width of 1 μm is used, the crystal growth speed of GaNP is 30 to 50 μm/hr. In case where the mask 24 having an opening width of 100 μm is used, the crystal growth speed of GaNP becomes 1 to 2 μm/hr significantly smaller than the former width.

What is more, the incorporated amount of P in GaNP changes significantly according to the crystal growth speed, and in case where the opening areas of the openings 24A are narrow as shown in FIG. 14, GaNP whose composition ratio of P is large is selectively grown. In case where the opening areas of the openings 24A are wide, on the other hand, GaNP whose composition ratio of P is small is selectively grown.

More specifically, in case where the opening has an opening area of 1×5 (=5) μm² or smaller, the crystal growth speed of GaNP is as fast as 30 to 50 μm/hr and GaNP whose P composition is about 15% is formed. In case where the opening has an opening area of about 20×50 (=1000) μm², the crystal growth speed of GaNP becomes as slow as 10 to 20 μm/hr and GaNP whose P composition is about 7 to 8% is formed. In case of the opening having a large opening area of 200×300 (=60000) μm² or greater, the crystal growth speed of GaNP becomes significantly slower to 1 to 2 μm/hr and GaNP whose P composition is about 2% is formed.

In the case of the device C, therefore, each GaN-based compound semiconductor which serves as a light emitting area (active layer) can be changed by adequately designing the sizes of the opening areas of the openings 24A of the mask 24 and the number of the openings 24A. This makes it possible to vary the band gap of each GaN-based compound semiconductor.

For example, if one light emitting area is allowed to have a composition for a red light, another light emitting area is allowed to have a composition for a blue light and the other one is allowed to have a composition for a green light and those areas are distributed in the proper ratio, the device C can emit a white light.

### EXAMPLE 1

The light emitting device A that has the layered structure shown in FIG. 1 was fabricated in the following manner.

First, the layered structure A₀ shown in FIG. 4 was produced by the gas-source molecular-beam epitaxy (GSMBE).

Specifically, the GaN buffer layer 2 with a thickness of 500 nm was formed on the sapphire substrate 1 at a growth temperature of 640° C. by using dimethylhydrazine (5×10⁻⁵ Torr) as the N source and metal Ga (5×10⁻⁷ Torr) as the Ga source. Then, the non-doped GaN layer 3 with a thickness of 2 μm was further formed on the GaN buffer layer 2 at a growth temperature of 850° C. by using ammonia (5×10⁻⁶ Torr) as the N source and metal Ga (5×10⁻⁷ Torr) as the Ga source.

Then, Al (1×10⁻⁷ Torr) and metal Mg (5×10⁻⁹ Torr) as a p-type dopant were added to the N source and Ga source and growth by GSMBE at a growth temperature of 850° C. was carried out to form the p-AlGaN layer 4 having a thickness of 10 μm. Then, the gas sources are changed to use ammonia (5×10⁻⁵ Torr) as the N source, metal Ga (5×10⁻⁷ Torr) as the Ga source and phosphine (5×10⁻⁷ Torr) as the P source and the active layer 5 of non-doped GaN_{0.97}P_{0.03} having a thickness of 50 nm was formed at a growth temperature of 780° C.

Then, the gas sources are changed to use ammonia (5×10⁻⁶ Torr), metal Ga (5×10⁻⁷ Torr), metal Al (1×10⁻⁷ Torr) and metal Si (5×10⁻⁹ Torr) as an n-type dopant and the n-AlGaN layer 6 having a thickness of 10 μm was formed at a growth temperature of 850° C. The cap layer 7 of n-GaN which has a thickness of 10 μm was formed on the n-AlGaN layer 6 at a growth temperature of 850° C. by using ammonia (5×10⁻⁶ Torr), metal Ga (5×10⁻⁷ Torr), metal Al (1×10⁻⁷ Torr) and metal Si (1×10⁻⁸ Torr), thereby yielding the layered structure A₀ shown in FIG. 4.

Next, the SiO₂ film was deposited on the surface of the cap layer 7 by plasma CVD and was then patterned with a photoresist. With the SiO₂ film used as a mask, a part of the layered structure A₀ was etched out to a part of the p-AlGaN layer 4 by wet etching, thereby partially exposing the surface of the p-AlGaN layer 4.

After the SiO₂ film was removed, an SiO₂ film was deposited again on the entire surface of the resultant structure and electrode openings were formed in that SiO₂ film. Then, Ta—Si was vapor-deposited on the cap layer 7 to form the n-type electrode 8 and Ni/Al was vapor-deposited on the p-AlGaN layer 4 to form the p-type electrode 9, thereby completing the light emitting device A shown in FIG. 1.

A voltage was applied to the p-n junction of this light emitting device and the emission peak and the luminance were checked by an electroluminescence method.

The light emitting device had an emission peak in the vicinity of 425 nm and demonstrated emission of a strong violet light.

For the purpose of comparison, a device which had the same structure as the light emitting device of the Example 1 except that ammonia (5×10⁻⁵ Torr) and metal Ga (5×10⁻⁷ Torr) alone were used for the active layer 5 and a non-doped GaN layer having a thickness of 50 nm was formed at a growth temperature of 850° C. was fabricated.

This light emitting device also had an emission peak near the wavelength of 380 nm but with a low luminance.

### EXAMPLE 2

The light emitting device A was fabricated in the same way as the Example 1 except that the semiconductor material for the active layer was GaN_{0.94}As_{0.02}P_{0.04}. The light emitting device had an emission peak in the vicinity of 460 nm and demonstrated emission of a blue light.

### EXAMPLE 3

The light emitting device B shown in FIG. 2 was fabricated in the following manner.

First, as shown in FIG. 5, the GaN buffer layer 12 with a thickness of 50 nm was formed on the sapphire substrate 1 at a growth temperature of 700° C. by GSMBE by using metal Ga (5×10⁻⁷ Torr) as the Ga source and dimethylhydrazine (6×10⁻⁶ Torr) as the N source. Then, the p-GaN layer 13 with a thickness of 2 μm was formed at a growth temperature of 850° C. by using ammonia (6×10⁻⁶ Torr) as the N source, metal Ga (5×10⁻⁷ Torr) as the Ga source and metal Mg (1×10⁻⁸ Torr) as a p-type dopant.

Then, the layer 14 of GaN_{0.99}P_{0.01} was grown at a growth temperature of 850° C. by using metal Ga (5×10⁻⁷ Torr) as the Ga source, ammonia (6×10⁻⁶ Torr) as the N source and tertiary butyl phosphine (1×10⁻⁶ Torr) as the P source (FIG. 6). At this time, the growth time was controlled in such a way that the thickness of GaN₁₋ₓPₓ became 1 to 2 ML.

The surface of the p-GaN layer 13 may be subjected to a surface treatment with an antisurfactant prior to the growth of the layer 14.

When the manipulation of crystal growth was stopped, the layer 14 or a two-dimensional film started self-alignment and was changed to multiple quantum dot structures 15A with sizes of about 1 to 2 ML, which were scattered like islands on the p-GaN layer 13 as shown in FIG. 7.

The quantum dot structures 15A could be observed by RHEED.

Then, the non-doped GaN layer 15B having a thickness of 2 to 3 nm was formed at a growth temperature of 850° C. by using metal Ga (5×10⁻⁷ Torr) as the Ga source and ammonia (6×10⁻⁶ Torr) as the N source to bury the quantum dot structures 15A, thus forming the single quantum well structure type active layer 15 of GaNP/GaN, as shown in FIG. 8.

Thereafter, the formation of the quantum dot structures 15A and the formation of the non-doped GaN layer that would bury the quantum dot structures 15A were repeated, thus yielding a multilayered structure having ten active layers 15 of a single quantum well structure type.

Then, the n-GaN layer 16 with a thickness of 1 μm was formed at a growth temperature of 850° C. by using metal Ga (5×10⁻⁷ Torr) as the Ga source, ammonia (6×10⁻⁶ Torr) as the N source and silane (1×10⁻⁸ Torr) as an n-type dopant (FIG. 9).

Then, a part of the layered structure shown in FIG. 9 was removed by dry etching to expose a part of the p-GaN layer 13. By using a photoresist and a mask of SiO₂ or the like, the p-type electrode 9 of Pt/Au and the n-type electrode 8 of Al/Ti/Au were respectively formed in the p-GaN layer 13 and the n-GaN layer 16 to form the pn junction. This completed the device B.

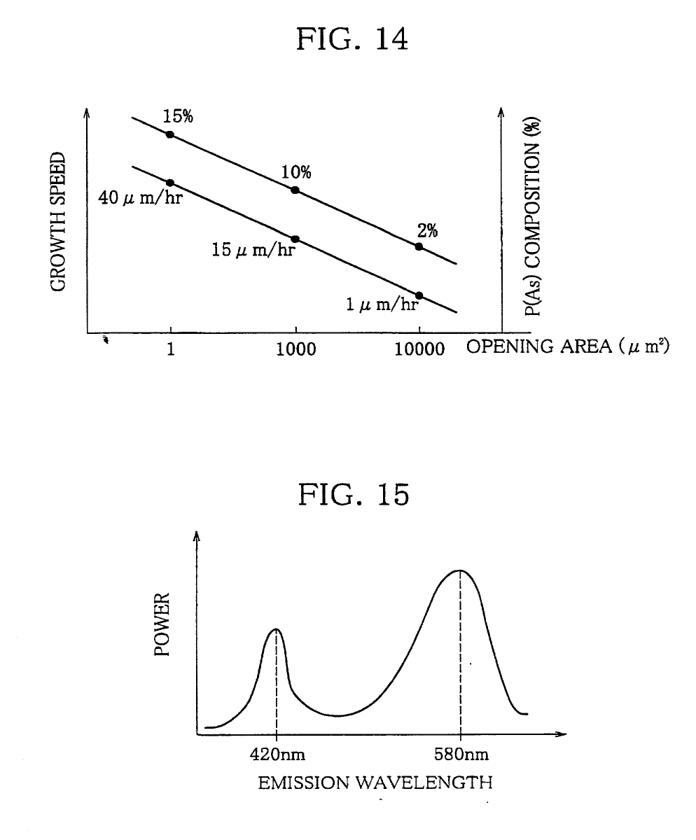

The device B was driven under the conditions of 4 V and 20 mA. As a result, a high-luminance blue light was observed in the vicinity of the wavelength of 420 nm as shown in FIG. 15.

### EXAMPLE 4

The light emitting device C shown in FIG. 3 was fabricated in the following manner.

First, as shown in FIG. 10, the GaN buffer layer 22 with a thickness of 50 nm was formed on the sapphire substrate 1 at a growth temperature of 650° C. by using trimethylgallium (25 sccm) as the Ga source and ammonia (2000 sccm) as the N source, and the p-GaN layer 23 with a thickness of 2 μm was further formed on the GaN buffer layer 22 at a growth temperature of 1050° C. by using trimethylgallium (25 sccm) as the Ga source, ammonia (2000 sccm) as the N source and biscyclopentadienyl magnesium (5 sccm) as a p-type dopant.

Next, an SiO₂ film having a thickness of about 100 nm was deposited on the p-GaN layer 23 by thermal CVD, and the SiO₂ film was patterned with a photoresist and was then subjected to wet etching using a hydrofluoric acid, forming the mask 24 having a plurality of openings 24A whose opening areas differed from one another as shown in FIG. 11.

Then, selective growth was carried out at a growth temperature of 950° C. by using trimethylgallium (25 sccm) as the Ga source, ammonia (2000 sccm) as the N source and tertiary butyl phosphine (10 sccm) as the P source, thereby filling the openings 24A with the light emitting areas 25A to 25E of GaNP as shown in FIG. 12.

At this time, the growth time was controlled in such a way that the thicknesses of light emitting areas became 3 to 100 nm.

This selective growth of GaNP forms a mixed crystal of GaN₁₋ₓPₓ in each opening 24A of the mask 24 wherein the value of x varies within a range of 0.02 to 0.15 in accordance with the opening area. In this case, when the mixed crystal is GaN_{0.98}P_{0.02}, the GaNP areas (active layers) 25A to 25E emit violet lights whereas when the mixed crystal is GaN_{0.85}P_{0.15}, the GaNP areas (active layers) 25A to 25E emit red lights.

Then, the n-GaN layer 26 with a thickness of 1 μm was formed at a growth temperature of 1050° C. by using trimethylgallium (25 sccm) as the Ga source, ammonia (2000 sccm) as the N source and silane (5 sccm) as an n-type dopant.

Then, a part of the layered structure was removed by dry etching to expose a part of the p-GaN layer 23, and the p-type electrode 9 of Pt/Au and the n-type electrode 8 of Al/Ti/Au were respectively formed in the p-GaN layer 23 and the n-GaN layer 26 for the formation of the pn junction by using a photoresist and a mask of SiO₂ or the like. This completed the device C.

As the device C was driven to cause the light emitting areas 25A to 25E to simultaneously emit lights, emission of a white light was demonstrated.

As apparent from the foregoing description, the GaN-based light emitting device according to the present invention emits a light with a high luminance. This is because lattice defects originated from the dissociation of N element at the time of crystal growth are compensated for by other V group elements.

Further, the GaN-based light emitting device according to the present invention can emit a light of any wavelength ranging from ultraviolet to infrared and can also emit a white light by adequately changing the composition ratio of N and other V group elements in the GaN-based compound semiconductor used for the active layer.

What is claimed is:

1. A GaN-based light emitting device comprising:
an active layer formed of a GaN-based compound semiconductor including at least two kinds of V group elements.

2. The GaN-based light emitting device according to claim 1, wherein a layered structure having a buffer layer of GaN, a cladding layer of non-doped GaN, a p-type cladding layer of p-AlGaN, said active layer of said GaN-based compound semiconductor, an n-type cladding layer of n-AlGaN and a cap layer of n-GaN laminated in the order named is provided on a substrate, an n-type electrode is formed on said cap layer and a p-type electrode is formed on said p-type cladding layer.

3. The GaN-based light emitting device according to claim 1, wherein said active layer is formed of non-doped GaNP or non-doped GaNAs.

4. The GaN-based light emitting device according to claim 2, wherein said active layer is formed of non-doped GaNP or non-doped GaNAs.

5. The GaN-based light emitting device according to claim 1, wherein said active layer includes an island-shaped quantum dot structure formed of a GaN-based compound semiconductor.

6. The GaN-based light emitting device according to claim 3, wherein said active layer includes an island-shaped quantum dot structure formed of a GaN-based compound semiconductor.

7. The GaN-based light emitting device according to claim 4, wherein said active layer includes an island-shaped quantum dot structure formed of a GaN-based compound semiconductor.

8. The GaN-based light emitting device according to claim 5, wherein said quantum dot structure is formed by self-alignment of one molecular layer or two molecular layers of said GaN-based compound semiconductor.

9. The GaN-based light emitting device according to claim 6, wherein said quantum dot structure is formed by self-alignment of one molecular layer or two molecular layers of said GaN-based compound semiconductor.

10. The GaN-based light emitting device according to claim 7, wherein said quantum dot structure is formed by self-alignment of one molecular layer or two molecular layers of said GaN-based compound semiconductor.

11. The GaN-based light emitting device according to claim 1, wherein said active layer is a plurality of light-emitting areas which are formed of a GaN-based compound semiconductor and have different compositions and different areas of light-emitting layers.

12. The GaN-based light emitting device according to claim 3, wherein said active layer is a plurality of light-emitting areas which are formed of a GaN-based compound semiconductor and have different compositions and different areas of light-emitting layers.

13. The GaN-based light emitting device according to claim 4, wherein said active layer is a plurality of light-emitting areas which are formed of a GaN-based compound semiconductor and have different compositions and different areas of light-emitting layers.

14. The GaN-based light emitting device according to claim 11, wherein said light-emitting areas are formed by selective growth using a mask having a plurality of openings with different opening areas.

15. The GaN-based light emitting device according to claim 12, wherein said light-emitting areas are formed by selective growth using a mask having a plurality of openings with different opening areas.

16. The GaN-based light emitting device according to claim 13, wherein said light-emitting areas are formed by selective growth using a mask having a plurality of openings with different opening areas.

17. The GaN-based light emitting device according to claim 1, wherein said V group elements are N and at least one kind selected from a group of As, P and Sb.

18. The GaN-based light emitting device according to claim 1, wherein said GaN-based compound semiconductor is a GaN-based compound semiconductor expressed by a formula:
GaN_{1-x-y}As_{y}Pₓ
where x and y are values which are not zero at the same time and satisfy 0<x+y<1.

19. The GaN-based light emitting device according to claim 2, wherein said GaN-based compound semiconductor is a GaN-based compound semiconductor expressed by a formula:
GaN_{1-x-y}As_{y}Pₓ
where x and y are values which are not zero at the same time and satisfy 0<x+y<1.

20. The GaN-based light emitting device according to claim 5, wherein said GaN-based compound semiconductor is a GaN-based compound semiconductor expressed by a formula:
GaN_{1-x-y}As_{y}Pₓ
where x and y are values which are not zero at the same time and satisfy 0<x+y<1.

21. The GaN-based light emitting device according to claim 6, wherein said GaN-based compound semiconductor is a GaN-based compound semiconductor expressed by a formula:
GaN_{1-x-y}As_{y}Pₓ
where x and y are values which are not zero at the same time and satisfy 0<x+y<1.

22. The GaN-based light emitting device according to claim 7, wherein said GaN-based compound semiconductor is a GaN-based compound semiconductor expressed by a formula:
GaN_{1-x-y}As_{y}Pₓ
where x and y are values which are not zero at the same time and satisfy 0<x+y<1.

23. The GaN-based light emitting device according to claim 8, wherein said GaN-based compound semiconductor is a GaN-based compound semiconductor expressed by a formula:
GaN_{1-x-y}As_{y}Pₓ
where x and y are values which are not zero at the same time and satisfy 0<x+y<1.

24. The GaN-based light emitting device according to claim 9, wherein said GaN-based compound semiconductor is a GaN-based compound semiconductor expressed by a formula:
GaN_{1-x-y}As_{y}Pₓ
where x and y are values which are not zero at the same time and satisfy 0<x+y<1.

25. The GaN-based light emitting device according to claim 10, wherein said GaN-based compound semiconductor is a GaN-based compound semiconductor expressed by a formula:
GaN_{1-x-y}As_{y}Pₓ
where x and y are values which are not zero at the same time and satisfy 0<x+y<1.

26. The GaN-based light emitting device according to claim 11, wherein said GaN-based compound semiconductor is a GaN-based compound semiconductor expressed by a formula:
GaN_{1-x-y}As_{y}Pₓ
where x and y are values which are not zero at the same time and satisfy 0<x+y<1.

27. The GaN-based light emitting device according to claim 12, wherein said GaN-based compound semiconductor is a GaN-based compound semiconductor expressed by a formula:
GaN_{1-x-y}As_{y}Pₓ
where x and y are values which are not zero at the same time and satisfy 0<x+y<1.

28. The GaN-based light emitting device according to claim 13, wherein said GaN-based compound semiconductor is a GaN-based compound semiconductor expressed by a formula:
GaN_{1-x-y}As_{y}Pₓ
where x and y are values which are not zero at the same time and satisfy 0<x+y<1.

29. The GaN-based light emitting device according to claim 18, wherein In substitutes for a part of Ga in said GaN-based compound semiconductor.

30. The GaN-based light emitting device according to claim 19, wherein In substitutes for a part of Ga in said GaN-based compound semiconductor.

31. The GaN-based light emitting device according to claim 20, wherein In substitutes for a part of Ga in said GaN-based compound semiconductor.

32. The GaN-based light emitting device according to claim 21, wherein In substitutes for a part of Ga in said GaN-based compound semiconductor.

33. The GaN-based light emitting device according to claim 22, wherein In substitutes for a part of Ga in said GaN-based compound semiconductor.

34. The GaN-based light emitting device according to claim 23, wherein In substitutes for a part of Ga in said GaN-based compound semiconductor.

35. The GaN-based light emitting device according to claim 24, wherein In substitutes for a part of Ga in said GaN-based compound semiconductor.

36. The GaN-based light emitting device according to claim 25, wherein In substitutes for a part of Ga in said GaN-based compound semiconductor.

37. The GaN-based light emitting device according to claim 26, wherein In substitutes for a part of Ga in said GaN-based compound semiconductor.

38. The GaN-based light emitting device according to claim 27, wherein In substitutes for a part of Ga in said GaN-based compound semiconductor.

39. The GaN-based light emitting device according to claim 28, wherein In substitutes for a part of Ga in said GaN-based compound semiconductor.

40. The GaN-based light emitting device according to claim 1, wherein said active layer has a multilayered structure.

41. The GaN-based light emitting device according to claim 2, wherein said active layer has a multilayered structure.

42. The GaN-based light emitting device according to claim 5, wherein said active layer has a multilayered structure.

43. The GaN-based light emitting device according to claim 6, wherein said active layer has a multilayered structure.

44. The GaN-based light emitting device according to claim 7, wherein said active layer has a multilayered structure.

45. The GaN-based light emitting device according to claim 8, wherein said active layer has a multilayered structure.

46. The GaN-based light emitting device according to claim 9, wherein said active layer has a multilayered structure.

47. The GaN-based light emitting device according to claim 10, wherein said active layer has a multilayered structure.

48. The GaN-based light emitting device according to claim 17, wherein said active layer has a multilayered structure.

49. The GaN-based light emitting device according to claim 18, wherein said active layer has a multilayered structure.

50. The GaN-based light emitting device according to claim 19, wherein said active layer has a multilayered structure.

51. The GaN-based light emitting device according to claim 20, wherein said active layer has a multilayered structure.

52. The GaN-based light emitting device according to claim 21, wherein said active layer has a multilayered structure.

53. The GaN-based light emitting device according to claim 22, wherein said active layer has a multilayered structure.

54. The GaN-based light emitting device according to claim 23, wherein said active layer has a multilayered structure.

55. The GaN-based light emitting device according to claim 24, wherein said active layer has a multilayered structure.

56. The GaN-based light emitting device according to claim 25, wherein said active layer has a multilayered structure.

57. The GaN-based light emitting device according to claim 29, wherein said active layer has a multilayered structure.

58. The GaN-based light emitting device according to claim 30, wherein said active layer has a multilayered structure.

59. The GaN-based light emitting device according to claim 31, wherein said active layer has a multilayered structure.

60. The GaN-based light emitting device according to claim 32, wherein said active layer has a multilayered structure.

61. The GaN-based light emitting device according to claim 33, wherein said active layer has a multilayered structure.

62. The GaN-based light emitting device according to claim 34, wherein said active layer has a multilayered structure.

63. The GaN-based light emitting device according to claim 35, wherein said active layer has a multilayered structure.

64. The GaN-based light emitting device according to claim 36, wherein said active layer has a multilayered structure.

65. The GaN-based light emitting device according to any one of claims 2, 4, 19, 22 and 25, wherein said p-type electrode is formed of Pt/Au, Ni/Au, Ag/Au, Pd/Pt/Au, Pt/Ni/Au or Ag/Ni/Au.

66. The GaN-based light emitting device according to any one of claims 2, 4, 19, 22 and 25, wherein said n-type electrode is formed of Ti/Al/Au, Al/Ti/Au, Ta—Si, Ti—Si, Al—Si or W—Si.
